(19) United States
(12) Patent Application Publication
(10) Pub. No.: US 2018/0215911 A1
(43) Pub. Date: Aug. 2, 2018

(54) RESIN COMPOSITION

(71) Applicants: AUTONETWORKS TECHNOLOGIES, LTD., Yokkaichi, Mie (JP); SUMITOMO WIRING SYSTEMS, LTD., Yokkaichi, Mie (JP); SUMITOMO ELECTRIC INDUSTRIES, LTD., Osaka-shi, Osaka (JP)

(72) Inventor: Takaaki HAMAGUCHI, Yokkaichi, Mie (JP)

(21) Appl. No.: 15/747,325

(22) PCT Filed: Jul. 20, 2016
(86) PCT No.: PCT/JP2016/071295

§ 371 Date: Jan. 24, 2018

(30) Foreign Application Priority Data
Aug. 5, 2015 (JP) 2015-155294

(51) Int. Cl. C08L 53/02; C08L 65/00

(52) U.S. Cl. CPC C08L 53/02; C08L 65/00

(57) ABSTRACT

A resin composition in which both excellent elongation characteristics and a high softening point can be achieved is provided. The resin composition contains 15 to 175 parts by mass of a terpene phenol copolymer with respect to 100 parts by mass of a styrene-ethylene/butadiene-styrene block copolymer. It is preferable that the terpene phenol copolymer has a weight-average molecular weight of 300 to 1500. The styrene-ethylene/butadiene-styrene block copolymer may be hydrogenated. The styrene-ethylene/butadiene-styrene block copolymer may be modified using maleic acid.

### CROSS REFERENCE TO RELATED APPLICATIONS

This application claims the priority of Japanese patent application JP2015-155294 filed on Aug. 5, 2015, the entire contents of which are incorporated herein.

### TECHNICAL FIELD

The present invention relates to a resin composition.

### BACKGROUND ART

A styrene-ethylene/butadiene-styrene block copolymer (referred to as “SEBS copolymer” hereinafter) is widely used in various applications such as automobile parts and industrial products. Additives such as a filler, a plasticizer, and a softening agent may be added to an SEBS copolymer in accordance with the application (Patent Documents 1 (JP 2014-31454A) and 2 (JP 2012-17392A), for example).

### SUMMARY

In recent years, use of resin compositions containing an SEBS copolymer in a high-temperature environment such as an engine room of an automobile has been studied. Resin compositions to be used in a high-temperature environment are required to have softening points higher than those of general-purpose resin compositions in order to maintain high strength. However, the SEBS copolymer has a low softening point because the polymer chain contains an intermediate rubber block. Therefore, resin compositions containing an SEBS copolymer are required to have softening points higher than that of the SEBS copolymer in order to use the resin compositions containing the SEBS copolymer in a high-temperature environment.

In general, a method for raising the softening point of a resin composition includes adding an inorganic filler such as silica, calcium carbonate or glass filler, or a tackifier. However, resin compositions containing an SEBS copolymer and an inorganic filler or the like are problematic in that, although their softening points can be raised, they decrease in elongation. Therefore, it is difficult to apply conventional resin compositions containing an SEBS copolymer to automobile parts and the like that are required to have high elongation.

The present application was achieved in view of the above-described background, and provides a resin composition in which both excellent elongation characteristics and a high softening point can be achieved.

An aspect of the present application is a resin composition containing 40 to 175 parts by mass of a terpene phenol copolymer with respect to 100 parts by mass of a styrene-ethylene/butadiene-styrene block copolymer (SEBS copolymer).

The above-mentioned resin composition contains a terpene phenol copolymer in an amount within the above-mentioned specific range with respect to 100 parts by mass of an SEBS copolymer. As a result, compared with conventional resin compositions obtained by adding an inorganic filler or the like to an SEBS copolymer, the softening point of the above-mentioned resin composition can be further raised while a decrease in elongation is suppressed.

As described above, both excellent elongation characteristics and a high softening point can be easily achieved, and therefore, the above-mentioned resin composition can be favorably used in resin components to be used in a high-temperature environment such as an engine room of an automobile, an insulating coating for an electric wire, and the like.

### DESCRIPTION OF EMBODIMENTS

In the above-mentioned resin composition, a binary copolymer including terpene and phenol, or a multi-component copolymer including three or more components that contains a structural unit derived from terpene and a structural unit derived from phenol as essential components can be used as the terpene phenol copolymer. These copolymers may be hydrogenated or their functional groups may be modified.

The content of the terpene phenol copolymer is 40 to 175 parts by mass with respect to 100 parts by mass of the SEBS copolymer. Setting the content of the terpene phenol copolymer to be within the above-mentioned specific range makes it possible to raise the softening point of the above-mentioned resin composition while suppressing a decrease in its elongation.

When the content of the terpene phenol copolymer is less than 15 parts by mass, the softening point of the above-mentioned resin composition is lower than that of the SEBS copolymer. Therefore, the content of the terpene phenol copolymer is set to be not less than 40 parts by mass from the viewpoint of raising the softening point of the resin composition.

On the other hand, when the content of the terpene phenol copolymer is more than 175 parts by mass, its elongation decreases excessively. Therefore, the content of the terpene phenol copolymer is set to be not more than 175 parts by mass from the viewpoint of suppressing a decrease in elongation of the above-mentioned resin composition. From the same viewpoint, the content of the terpene phenol copolymer is preferably set to be not more than 155 parts by mass, more preferably not more than 150 parts by mass, even more preferably not more than 130 parts by mass, and even more preferably not more than 110 parts by mass.

It is preferable that the terpene phenol copolymer has a weight-average molecular weight of 300 to 1500. In this case, the effect of suppressing a decrease in elongation of the above-mentioned resin composition and the effect of raising the softening point can be further improved.

The SEBS copolymer may be hydrogenated. In this case, the elongation of the above-mentioned resin composition can be further improved.

The SEBS copolymer may be modified using an unsaturated carboxylic acid such as maleic anhydride. In this case, the above-mentioned resin composition can be provided with adhesiveness, and therefore, the resin composition can also be used as an adhesive.

Conventional resin compositions containing an SEBS copolymer and an inorganic filler or the like are problematic in that the adhesive strength decreases as the content of the inorganic filler or the like increases. In contrast, compared with the case where the content of the inorganic filler or the like increases, the adhesive strength of the above-mentioned resin composition is less likely to decrease when the content of the terpene phenol copolymer increases. Moreover, as described above, the softening point of the resin composition can be raised by mixing the terpene phenol copolymer in the SEBS copolymer. Therefore, the resin composition can be favorably used as an adhesive to be used in a high-temperature environment such as an engine room of an automobile, for example.

When the above-mentioned resin composition is used as an adhesive, the content of the terpene phenol copolymer is preferably set to be not less than 50 parts by mass. In this case, the adhesive strength of the resin composition can be made higher than that of the SEBS copolymer.

The above-mentioned resin composition may contain additives that are commonly used in resins, such as an antioxidant, a plasticizer, a flame retardant, a thermal stabilizer, a filler, and a coloring agent, as long as the above-described functions and effects are not impaired.

### EXAMPLES

Examples of the above-mentioned resin composition will be described hereinafter. In these examples, resin compositions (samples 1 to 7; see Table 1) containing an SEBS copolymer and a terpene phenol copolymer were prepared by mixing the following resins. In addition, for comparison with samples 1 to 7, a sample containing only the SEBS copolymer (sample 8; see Table 2) and resin compositions (samples 9 to 11; see Table 2) obtained by mixing the SEBS copolymer and a hydrogenated aromatic modified terpene resin were prepared. The elongations, softening points, and tensile shear adhesive strengths of these samples were measured.

The following are the resins used in these examples.
SEBS copolymer, FG1924GT (manufactured by Kraton Polymers)
Terpene phenol copolymer, YS POLYSTER T160 (manufactured by Yasuhara Chemical Co., Ltd.)
Hydrogenated aromatic modified terpene resin, CLEARON (registered trademark) M125 (manufactured by Yasuhara Chemical Co., Ltd.)

It should be noted that the intermediate rubber block in the polymer chain of the SEBS copolymer (FG1924GT) is hydrogenated and is modified using maleic anhydride. The terpene phenol copolymer (YS POLYSTER T160) has a weight-average molecular weight of 700.

### Measurement of Elongation

The resins were dissolved and mixed in toluene at ratios shown in Tables 1 and 2. Each of the resultant solutions was cast on a polytetrafluoroethylene sheet, and then the toluene was evaporated to form a film having a thickness of 0.1 to 0.4 mm. This film was punched out with a No. 3 dumbbell-shaped punching blade prescribed in JIS K6251, and a test piece was thus obtained. The elongation at break of the test piece was measured using a tensile testing machine (“Autograph (registered trademark) AG-A” manufactured by Shimadzu Corporation). The measurement of elongation was performed under conditions in which the initial gauge length was 20 mm, the tension speed was 100 mm/min, and the testing temperature was room temperature.

### Measurement of Softening Point

A rectangular test piece was obtained from the above-mentioned film, and the viscoelasticity was measured using a dynamic viscoelasticity measurement apparatus (“DMA2980” manufactured by TA Instruments Japan). The storage elastic modulus values E′ of the samples of these examples slowly decreased from the initial measurement values as the temperature increased. The values E′ rapidly decreased near the softening points. Based on these results, temperatures at which the values E′ reached 1 MPa were given as the softening points. It should be noted that the measurement of viscoelasticity was performed under conditions in which the temperature at the start of the measurement was −50° C., the temperature at the end of the measurement was 200° C., and the temperature increasing speed was 10° C./min.

### Measurement of Tensile Shear Adhesive Strength

The tensile shear adhesive strength was measured using a method according to JIS K6850. Specifically, test pieces were prepared as follows. First, adherends having a rectangular shape made of a crosslinked polyethylene resin and second adherends having a rectangular shape made of a connector material were prepared in advance. The resins were dissolved and mixed in toluene at ratios shown in Tables 1 and 2. Each of the resultant solutions was applied to the end portions in the longitudinal direction of the first adherend, and the end portions in the longitudinal direction of the second adherend were adhered to the portions to which the solution had been applied. Thereafter, the toluene was evaporated to produce a test piece.

The tensile shear adhesive strength of the test piece was measured using a tensile testing machine (“Autograph AG-A” manufactured by Shimadzu Corporation). It should be noted that the measurement of tensile shear adhesive strength was performed under conditions in which the tension speed was 100 mm/min, and the testing temperature was room temperature.

Tables 1 and 2 show the test results.

TABLE 1

| | | Sample 1 | Sample 2 | Sample 3 | Sample 4 | Sample 5 | Sample 6 | Sample 7 |
|---|---|---|---|---|---|---|---|---|
| SEBS copolymer | parts | 100 | 100 | 100 | 100 | 100 | 100 | 100 |
| | by | | | | | | | |
| | mass | | | | | | | |
| Terpene phenol | parts | 2.5 | 10 | 25 | 50 | 100 | 150 | 200 |
| copolymer | by | | | | | | | |
| | mass | | | | | | | |
| Elongation | % | 850 | 850 | 850 | 850 | 840 | 630 | — |
| Softening point | ° C. | 121 | 137 | 165 | 168 | 194 | 182 | 160 |
| Tensile shear | kPa | 980 | 1100 | 1100 | 1220 | 1250 | 960 | — |
| adhesive strength | | | | | | | | |

TABLE 2

| | | Sample | Sample | Sample | Sample |
|---|---|---|---|---|---|
| | | 8 | 9 | 10 | 11 |
| SEBS copolymer | parts by | 100 | 100 | 100 | 100 |
| | mass | | | | |
| Hydrogenated | parts by | 0 | 2.5 | 10 | 100 |
| aromatic modified | mass | | | | |
| terpene resin | | | | | |
| Elongation | % | 1000 | 820 | 200 | 5 |
| Softening point | ° C. | 144 | 125 | 125 | 125 |
| Tensile shear | kPa | 1100 | 980 | 750 | 410 |
| adhesive strength | | | | | |

As is clear from Tables 1 and 2, samples 3 to 6, which contained the terpene phenol copolymer in an amount within the above-mentioned specific range, were given softening points higher than that of sample 8, which contained only the SEBS copolymer. Moreover, samples 3 to 6 were given softening points higher than those of samples 9 to 11, which contained a resin other than the terpene phenol copolymer, while a decrease in elongation and a decrease in tensile shear adhesive strength were suppressed.

It can be understood from these results that samples 3 to 6 have excellent shear adhesive strength even in a high-temperature environment. Therefore, samples 3 to 6 are favorably used as adhesives to be used in a high-temperature environment.

Moreover, samples 3 to 5, which contained the terpene phenol copolymer in an amount of 25 to 100 parts by mass, were given tensile shear adhesive strengths higher than that of sample 8, which contained only the SEBS copolymer.

Samples 1 and 2 contained the terpene phenol copolymer in amounts smaller than the above-mentioned specific range, and therefore, their softening points were lower than that of sample 8. Sample 7 contained the terpene phenol copolymer in an amount larger than the above-mentioned specific range, and therefore, the test pieces for the measurement of elongation and the measurement of tensile shear adhesive strength could not be produced therefrom.

At present, a mechanism by which resin compositions containing an SEBS copolymer and a terpene phenol copolymer exhibit the above-mentioned functions and effects is not completely clarified. An example of the mechanism that is conceivable at this point in time is as follows.

SEBS copolymers include styrene blocks having relatively high rigidity, and an ethylene/butadiene block (intermediate rubber block) having relatively high elasticity, and form a three-dimensional mesh-like structure due to the aggregation of the styrene blocks. It is thought that the terpene phenol copolymer is likely to be taken into the styrene block aggregation phase in a state in which the terpene phenol copolymer and the SEBS copolymer are mixed. As a result, the terpene phenol copolymer exhibits an effect of reinforcing the aggregation phase, and therefore, it is thought that the softening point can be raised and the tensile shear adhesive strength can be improved.

On the other hand, it is thought that the aromatic modified terpene resin is likely to be taken into a phase in which the ethylene/butadiene blocks are plentiful. As a result, it is thought that the rubber elasticity exhibited by the ethylene/butadiene blocks is suppressed, and the elongation of the resin composition thus decreases.

In the above-described examples, the resin compositions containing the SEBS copolymer modified using maleic acid and the terpene phenol copolymer are shown as examples, but the functions and effects of raising the softening points of the resin compositions and suppressing a decrease in elongation of the resin compositions can also be exhibited even when an SEBS copolymer that has not been modified using maleic acid is used. Therefore, it can be easily understood from the results of the above-described examples that the above-mentioned resin compositions are favorably used as materials of automobile parts such as grommets, tubes for protection of electric wires, and insulating coatings for electric wires.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A resin composition containing 40 to 175 parts by mass of a terpene phenol copolymer with respect to 100 parts by mass of a styrene-ethylene/butadiene-styrene block copolymer.

2. The resin composition according to claim 1, wherein the terpene phenol copolymer has a weight-average molecular weight of 300 to 1500.

3. The resin composition according to claim 1, wherein the styrene-ethylene/butadiene-styrene block copolymer is hydrogenated.

4. The resin composition according to claim 1, wherein the styrene-ethylene/butadiene-styrene block copolymer is modified using an unsaturated carboxylic acid.

5. The resin composition according to claim 1, which is to be used in an automobile.
